(19) United States
(12) Patent Application Publication
(10) Pub. No.: US 2025/0096489 A1
(43) Pub. Date: Mar. 20, 2025

(54) CONNECTION TERMINAL

(71) Applicant: XIAMEN GHGM INDUSTRIAL TRADE CO.,LTD, XIAMEN (CN)

(72) Inventor: BINGSHUI CHEN, XIAMEN (CN)

(21) Appl. No.: 18/522,266

(22) Filed: Nov. 29, 2023

(30) Foreign Application Priority Data
Sep. 14, 2023 (CN) 202311185003.2

(51) Int. Cl. H01R 9/24

(52) U.S. Cl. CPC H01R 9/2416

(57) ABSTRACT

A connection terminal, including at least one clamping spring, at least one controlling handle, and a controlling component. The at least one controlling handle is configured to control the at least one clamping spring and being movable between an open position and a closed position. The controlling component is a tension component, the tension component moves in a non-linear manner and is configured to support. When the at least one controlling handle is pivoted from the closed position to the open position, a clamping portion of the at least one clamping spring is opened through a tensile force of the tension component acting on the at least one clamping spring. The controlling component is disposed between the at least one controlling handle and the at least one clamping spring to open and close the clamping portion of the at least one clamping spring.

### TECHNICAL FIELD

The present disclosure relates to a technical field of electrical connectors, and in particular to a connection terminal.

### BACKGROUND

Current electrical connectors, in particular jointing clamp products, each generally uses a handle to perform a switching operation on a clamping portion, so as to achieve electrical connection after inserting wires.

However, even current handles each has a relatively compact structural design on a plastic housing and an optimized operation mode, a partial tensile force is generally wasted, so that the rest tensile force can aim to operate, which is not beneficial to manufacturing and use. Moreover, an operation period of each of the current handles on an inner conductive sheet is relatively long, on the one hand, the switching operation is delayed, so that feedback is not immediate, on the other hand, an internal connection cooperation of each of the current electrical connectors is not facilitated, so that a product design hits a bottleneck.

### SUMMARY

Based on above, the present disclosure aims to provide a connection terminal to solve above problems.

The present disclosure provides following technical solutions.

The present disclosure provides a connection terminal, including at least one clamping spring, at least one controlling handle, and a controlling component. The at least one controlling handle is configured to control the at least one clamping spring and being movable between an open position and a closed position. The controlling component is a tension component, the tension component moves in a non-linear manner and is configured to support. When the at least one controlling handle is pivoted from the closed position to the open position, a clamping portion of the at least one clamping spring is opened through a tensile force of the tension component acting on the at least one clamping spring.

Furthermore, the non-linear manner is a moving manner of freely swinging the controlling component after being limited by an external force.

Furthermore, the controlling component is detachably connected between the at least one controlling handle and the at least one clamping spring. When the at least one controlling handle is located at the open position, the controlling component is located at a first position, and when the at least one controlling handle is located at the closed position, the controlling component is switched to a second position along swinging points.

Furthermore, the swinging points are located on the controlling component, and the swinging points correspond to different stages of movement of the controlling component and are defined in a same straight-line direction.

Furthermore, the controlling component is a hook component, the hook component is in a surrounding shape having an opening, an opening end of the hook component is hooked on the at least one clamping spring, and a closed end of the hook component is opposite to the open end of the hook component and is hung on the at least one controlling handle.

Furthermore, the at least one controlling handle includes a hooking portion partially sleeved on the closed end of the hook component, the at least one controlling handle directly stands on a plastic housing of the connection terminal, and the at least one controlling handle is movably accommodated in a mounting cavity of the plastic housing through the controlling component.

Furthermore, the at least one clamping spring includes a contact leg, a connecting section, a bent portion, a clamping leg, and a bus bar. The clamping leg and the bus bar form the clamping portion of the at least one clamping spring, a controlling section is formed between the clamping leg and the bent portion, and the controlling section includes joint portions partially sleeved on the open end of the hook component.

Furthermore, at least two joint portions are provided adjacent to each other, and the at least two joint portions have different tensile force levels for matching the controlling component.

Furthermore, the plastic housing includes a protruding column for supporting the bent portion and a protruding block for supporting the connecting section, and the contact leg is bent and attached to an outer periphery of the protruding block.

Furthermore, the contact leg extends to be connected to the bus bar, and the bus bar includes pin components extending downwards or backwards.

According to above technical solutions, the present disclosure achieves following technical effects.

According to the connection terminal of the present disclosure, the controlling component is disposed between the at least one controlling handle and the at least one clamping spring to open and close the clamping portion of the at least one clamping spring, and the controlling component may quickly and efficiently control the at least one clamping spring through the tensile force by means of moving in the non-linear manner after switching a position of the at least one controlling handle, moreover, moving in the non-linear manner enables the controlling component to be in close connection and cooperation to trigger the at least one clamping spring, so that situations of delay in daily operation are greatly reduced, feedback of switching is more rapid, internal components of the connection terminal may have a compact design to achieve a more significant effect.

### BRIEF DESCRIPTION OF DRAWINGS

FIG. 1 is a structural schematic diagram of a connection terminal according to one embodiment of the present disclosure.

FIG. 2 is cross-sectional schematic diagram of the connection terminal taken from FIG. 1.

FIG. 3 is a schematic diagram illustrating the controlling handle shown in FIG. 2 switching from a closed position to an open position.

FIG. 4 is the cross-schematic diagram of FIG. 2 shown in another angle.

FIG. 5 is the cross-schematic diagram of FIG. 2 shown in another angle.

FIG. 6 is a partially disassembled schematic diagram of the connection terminal according to one embodiment of the present disclosure.

FIG. 7 is a schematic diagram illustrating cooperation of a controlling handle, a controlling component, and a clamping spring of the connection terminal according to one embodiment of the present disclosure.

FIG. 8 is a schematic diagram illustrating the cooperation shown in FIG. 7 in another angle.

FIG. 9 is a structural schematic diagram of a bus bar shown in FIG. 7 having pin components extending backwards.

Reference numerals in the drawings: 1. clamping spring; 2. controlling handle; 3. controlling component; 4. hook component; 5. hooking portion; 6. plastic housing; 7. contact leg; 8. connecting section; 9. bent portion; 10. clamping leg; 11. bus bar; 12-. joint portion; 13. protruding column; 14. protruding block; 15. pin component.

### DETAILED DESCRIPTION

In order to make objectives, technical solutions and advantages of embodiments of the present disclosure clearer, the technical solutions in the embodiments of the present disclosure are clearly and completely described below with reference to accompanying drawings in the embodiments of the present disclosure. Obviously, the described embodiments are part of the embodiments of the present disclosure, rather than all embodiments. All other embodiments obtained by those who skilled in the art based on the embodiments of the present disclosure without creative efforts shall fall within protection scopes of the present disclosure. Therefore, the following detailed description of the embodiments of the present disclosure provided in the accompanying drawings is not intended to limit the scopes of the present disclosure, but merely represents a selected embodiment of the present disclosure. All other embodiments obtained by those who skilled in the art based on the embodiments of the present disclosure without creative efforts shall fall within the protection scopes of the present disclosure.

Embodiments are as follow.

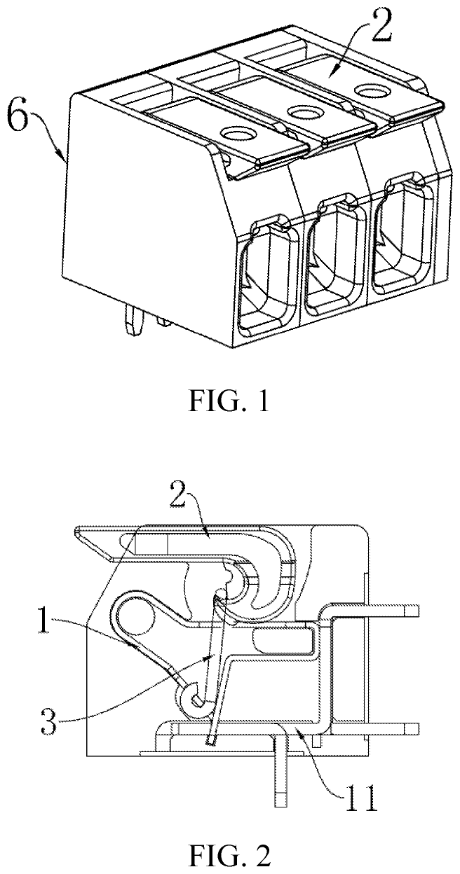

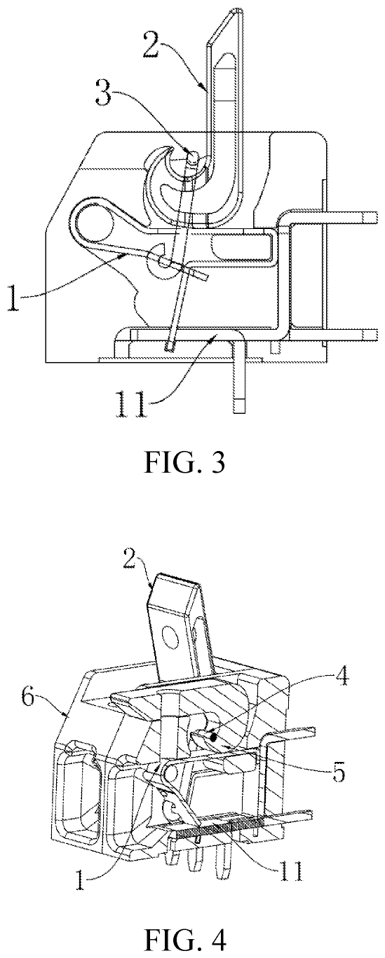

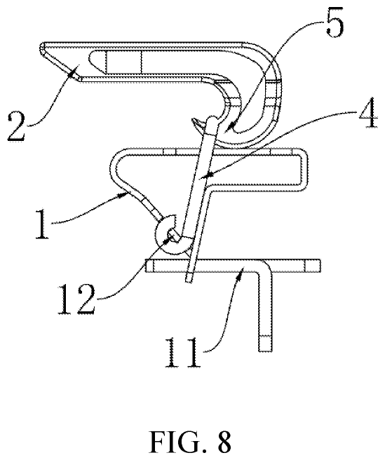

As shown in FIGS. 1-9, the present disclosure provides a connection terminal, including at least one clamping spring 1, at least one controlling handle 2, and a controlling component 3. The at least one controlling handle 2 is configured to control the at least one clamping spring 1 and being movable between an open position and a closed position. The controlling component 3 is a tension component, the tension component moves in a non-linear manner and is configured to support. When the at least one controlling handle 2 is pivoted from the closed position to the open position, a clamping portion of the at least one clamping spring 1 is opened through a tensile force of the tension component acting on the at least one clamping spring 1.

The controlling component 3 is disposed between the at least one controlling handle 2 and the at least one clamping spring 1 to open and close the clamping portion of the at least one clamping spring 1, and the controlling component 3 may quickly and efficiently control the at least one clamping spring 1 through the tensile force by means of moving in the non-linear manner after switching a position of the at least one controlling handle 2, moreover, moving in the non-linear manner enables the controlling component 3 to be in close connection and cooperation to trigger the at least one clamping spring 1, so that situations of delay in daily operation are greatly reduced, feedback of switching is more rapid, internal components of the connection terminal may have a compact design to achieve a more significant effect.

In one embodiment, the non-linear manner is a moving manner of freely swinging the controlling component 3 after being limited by an external force. Specifically, moving in a linear manner refers to movement of an object along a linear trajectory, such as translation and linear motion, moving in the non-linear manner refers to the movement of the object along a curve or an irregular trajectory, such as rotating, zooming, bouncing, bending, etc. In the embodiment, the controlling component 3 freely swings as moving in the non-linear manner, thereby effectively controlling the at least one clamping spring 1.

In one embodiment, the controlling component 3 is detachably connected between the at least one controlling handle 2 and the at least one clamping spring 1. When the at least one controlling handle 2 is located at the open position, the controlling component 3 is located at a first position, and when the at least one controlling handle 2 is located at the closed position, the controlling component 3 is switched to a second position along swinging points. The swinging points are located on the controlling component 3, and the swinging points correspond to different stages of movement of the controlling component and are defined in a same straight-line direction. Therefore, the controlling component 3 freely swings in the non-linear manner to be detachably connected between the at least one controlling handle 2 and the at least one clamping spring 1, so as to achieve more efficient and rapid tension feedback.

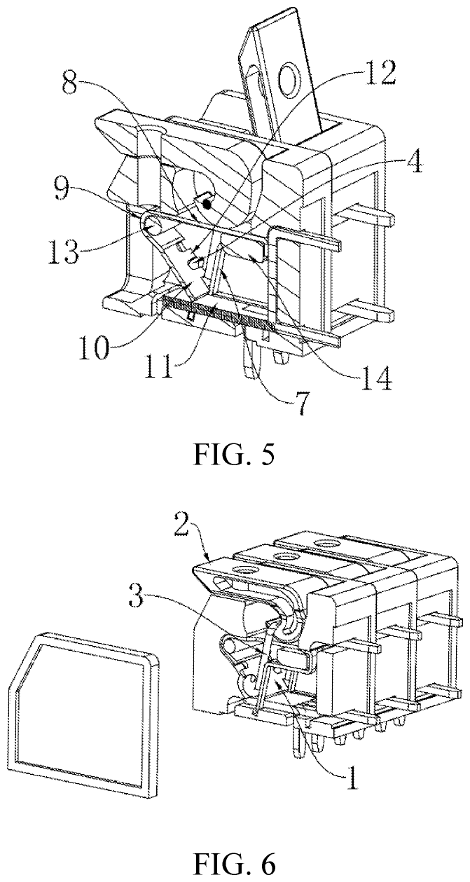

As shown in FIGS. 4 and 5, the controlling component 3 is a hook component 4, the hook component 4 is in a surrounding shape having an opening, an opening end of the hook component is hooked on the at least one clamping spring 1, and a closed end of the hook component is opposite to the open end of the hook component and is hung on the at least one controlling handle 2. Specifically, the hook component 4 is integrally formed by bending a metal strip and has an elastic force, and the hook component 4 pulls the at least one clamping spring 1 through a hoisting manner when the at least one controlling handle 2 switches positions, which enhances connectivity between the hook component 4 and the at least one clamping spring 1.

In one embodiment, the at least one controlling handle 2 includes a hooking portion 5 partially sleeved on the closed end of the hook component 4, the at least one controlling handle 2 directly stands on a plastic housing 6 of the connection terminal, and the at least one controlling handle 2 is movably accommodated in a mounting cavity of the plastic housing 6 through the controlling component 3. The at least one controlling handle 2 is rotatably accommodated in the mounting cavity, a hinge shaft connection is omitted between the at least one controlling handle 2 and the mounting cavity of the plastic housing 6, and the at least one controlling handle 2 is directly disposed between the hook component 4 and the hooking portion 5 of the at least one controlling handle 2 by hooking the hook component 4 on the hooking portion 5 of the at least one controlling handle 2, thereby simplifying a rotation design of the at least one controlling handle 2.

It should be noted that the plastic housing 6 in the embodiment is composed of at least three independent housing pieces, and the at least three independent housing pieces are capable of being assembled. A first housing piece located at one side has a detachable outer wall, and the at least one clamping spring 1, the controlling component 3, and the at least one controlling handle 2 are correspondingly exposed through detaching the detachable outer wall.

As shown in FIGS. 5, 7, and 8, in the embodiment, the at least one clamping spring 1 includes a contact leg 7, a connecting section 8, a bent portion 9, a clamping leg 10, and a bus bar 11. The clamping leg 10 and the bus bar 11 form the clamping portion of the at least one clamping spring 1, a controlling section is formed between the clamping leg 10 and the bent portion 9, and the controlling section includes joint portions 12 partially sleeved on the open end of the hook component 4. Thereby, the clamping leg 10 and the bus bar 11 cooperate to form the clamping portion of the at least one clamping spring 1, and pulling the clamping leg 10 may open or close the clamping portion of the at least one clamping spring 1. The contact leg 7 is specifically sleeved on the bus bar 11, and the contact leg 7 is in electrical contact with the bus bar 11. The connecting section 8 is configured to connect the clamping leg 10 with the contact leg 7, and the bent portion 9 is configured to provide an elastic force for an entire pulling process.

At least two joint portions 12 are provided adjacent to each other, and the at least two joint portions 12 have different tensile force levels for matching the controlling component 3. Specifically, each of the at least two joint portions 12 is of a toothed structure, and an end portion of the hook component 4 is bent and sleeved on the toothed structure to for close connection. Two of the least two joint portions 12 respectively disposed on a front outer side and a rear outer side of the clamping leg 10 may be selectively connected to the hook component 4, and correspondingly matched with different pulling forces acting on the at least one controlling handle 2 for normal use.

The plastic housing 6 includes a protruding column 13 for supporting the bent portion 9 and a protruding block 14 for supporting the connecting section 8, and the contact leg 7 is bent and attached to an outer periphery of the protruding block 14. The bent portion 9 is bent to form on an outer side of the protruding column 13, and elastic bending of the clamping leg 10 is further improved by the protruding column 13. And, a first end of the connecting section 8 stands on the protruding column 13, a second end of the connecting section 8 is bent on the protruding block 14, thereby effectively limiting the at least one clamping spring 1, and the contact leg is obliquely disposed on a bending portion of the connecting section 8.

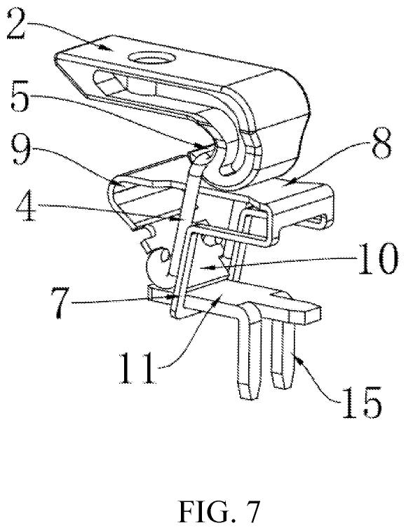

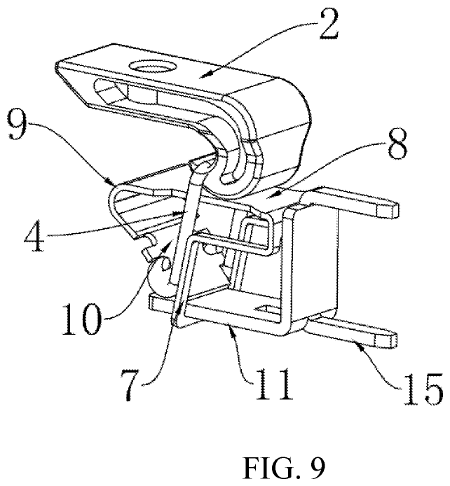

The contact leg 7 extends to be connected to the bus bar 11, and the bus bar 11 includes pin components 15 (as shown in FIGS. 7 and 9) extending downwards or backwards. Specifically, the contact leg 7 is frame-shaped and clamped on the bus bar 11, so that the at least one clamping spring 1 and the bus bar 11 are in closer connection. Moreover, providing the pin components 15 extending downwards on the bus bar 11 and providing the pin components 15 extending backwards on the bus bar 11 are respectively applicable to different power consumption scenarios.

The foregoing is only preferred embodiments of the present disclosure, and the protection scopes of the present disclosure are not limited to the above embodiments, and all technical solutions belonging to a concept of the present disclosure belong to the protection scopes of the present disclosure.

What is claimed is:

1. A connection terminal, comprising:
at least one clamping spring;
at least one controlling handle; and
a controlling component;
wherein the at least one controlling handle is configured to control the at least one clamping spring and being movable between an open position and a closed position; the controlling component is a tension component, the tension component moves in a non-linear manner and is configured to support; when the at least one controlling handle is pivoted from the closed position to the open position, a clamping portion of the at least one clamping spring is opened through a tensile force of the tension component acting on the at least one clamping spring.

2. The connection terminal according to claim 1, wherein the non-linear manner is a moving manner of freely swinging the controlling component after being limited by an external force.

3. The connection terminal according to claim 2, wherein the controlling component is detachably connected between the at least one controlling handle and the at least one clamping spring; when the at least one controlling handle is located at the open position, the controlling component is located at a first position, and when the at least one controlling handle is located at the closed position, the controlling component is switched to a second position along swinging points.

4. The connection terminal according to claim 3, wherein the swinging points are located on the controlling component, and the swinging points correspond to different stages of movement of the controlling component and are defined in a same straight-line direction.

5. The connection terminal according to claim 1, wherein the controlling component is a hook component, the hook component is in a surrounding shape having an opening, an opening end of the hook component is hooked on the at least one clamping spring, and a closed end of the hook component is opposite to the open end of the hook component and is hung on the at least one controlling handle.

6. The connection terminal according to claim 5, wherein the at least one controlling handle comprises a hooking portion partially sleeved on the closed end of the hook component, the at least one controlling handle directly stands on a plastic housing of the connection terminal, and the at least one controlling handle is movably accommodated in a mounting cavity of the plastic housing through the controlling component.

7. The connection terminal according to claim 6, wherein the at least one clamping spring comprises a contact leg, a connecting section, a bent portion, a clamping leg, and a bus bar; the clamping leg and the bus bar form the clamping portion of the at least one clamping spring, a controlling section is formed between the clamping leg and the bent portion, and the controlling section comprises joint portions partially sleeved on the open end of the hook component.

8. The connection terminal according to claim 7, wherein at least two joint portions are provided adjacent to each other, and the at least two joint portions have different tensile force levels for matching the controlling component.

9. The connection terminal according to claim 7, wherein the plastic housing comprises a protruding column for supporting the bent portion and a protruding block for supporting the connecting section, and the contact leg is bent and attached to an outer periphery of the protruding block.

10. The connection terminal according to claim 9, wherein the contact leg extends to be connected to the bus bar, and the bus bar comprises pin components extending downwards or backwards.
